(19) United States
(12) Patent Application Publication
(10) Pub. No.: US 2009/0190905 A1
(43) Pub. Date: Jul. 30, 2009

(54) Regulator Circuit for an Electric Motor, Provided with a Microprocessor

(75) Inventors: Heino Marten Burema, Mierlo (NL); Gerardus Elisabeth Joseph Maria Pas, Valkenswaard (NL)

Correspondence Address: DeMont & Breyer, LLC, 100 Commons Way, Ste. 250, Holmdel, NJ, 07733, US

(73) Assignee: ELECTRISCHE APPARATENFABRIEK CAPAX B.V., Eindhoven (NL)

(21) Appl. No.: 11/996,286

(22) PCT Filed: Jul. 19, 2006
(86) PCT No.: PCT/NL06/50181

§ 371 Date: Feb. 27, 2009

(30) Foreign Application Priority Data
Jul. 22, 2005 (NL) 1029587

(51) Int. Cl. H02P 7/29

(52) U.S. Cl. 388/819

(57) ABSTRACT

The invention relates to a regulator circuit for controlling the power fed to an electric motor from a voltage source, wherein the regulator circuit comprises a semiconductor switching element connected in series to the electric motor and the voltage source for the purpose of controlling the power fed to the electric motor, a control circuit for controlling the semiconductor switching element, and a first operating element for operating the control circuit by means of an operating signal generated by the operating element and fed to the control circuit, wherein a microprocessor is incorporated in the control circuit. The microprocessor can be adapted to control numerous functions within the regulator circuit, in particular monitoring and safety functions. It is however also possible for the microprocessor to be adapted to control the power fed to the electric motor subject to the operating signal. This can relate to performing of this single function as well as to performing this function in combination with safety functions.

The present invention relates to a regulator circuit for regulating the power fed to an electric motor from a voltage source, wherein the regulator circuit comprises a semiconductor switching element connected in series to the electric motor and the voltage source for the purpose of regulating the power fed to the electric motor, a control circuit for controlling the semiconductor switching element, and a first operating element for operating the control circuit by means of an operating signal generated by the operating element and fed to the control circuit.

Such a regulator circuit is generally known as regulator circuit in for instance electric hand tools. The market requires an increasingly greater functionality of such tools, which makes the control of the power to be fed to the electric motor more complicated. This is not only the case for electric hand tools, but also for other apparatus and devices in which such elements are used, such as electric kitchen appliances.

The object of the present invention is to provide such a regulator circuit which is better suited to carrying out the above stated monitoring and control functions.

This objective is achieved by such a regulator circuit, wherein a microprocessor is incorporated in the regulator circuit. It is noted here that the presence of an electric motor, which is usually formed by a direct current motor operating with carbon brushes and a commutator, causes much electrical interference, which can be disadvantageous for microelectronics. The skilled person will not therefore be likely to apply microprocessors in such an environment.

The microprocessor can be adapted to control numerous functions within the regulator circuit, in particular monitoring and safety functions. It is however also possible for the microprocessor to be adapted to control the power fed to the electric motor subject to the operating signal. This can relate to performing of this single function as well as to performing this function in combination with safety functions.

According to a subsequent preferred embodiment, the microprocessor comprises a memory in which is stored a characteristic for the relation between the operating signal and the power fed to the electric motor. It hereby becomes possible to provide an unambiguous relation between the two quantities. It is also noted that time and history-dependent relations, such as hysteresis functions, can also be included here. It is precisely microprocessors that are particularly well suited for implementing such functions.

Yet another preferred embodiment provides the measure that at least two characteristics are stored in the memory of the microprocessor and that the microprocessor is adapted to make a choice between the characteristics. This variant provides the option of adjusting the characteristic of the relation between input signal and power to be fed to the motor subject to circumstances.

The choice between the different characteristics can be made by a selection switch. The user can hereby choose between different operating modes, for instance drilling into wood or drilling into a concrete wall in the case of a drilling machine. This option makes it possible to choose an appropriate characteristic for the relevant situation. The choice between the different operating modes can also be determined by the conditions in the appliance itself. It is thus possible to provide the motor with load indicating means, wherein the load indicating means are adapted to generate a selection signal. In the case of imminent overload of the motor this provides the option of switching to another characteristic which loads the motor less. The increasing pressure of price dictates that the motors and other elements are given lighter dimensions and are thus loaded more heavily, whereby the above mentioned monitoring function becomes increasingly more relevant.

A preferred embodiment provides the measure that the load indicating means are provided with means for measuring the magnitude of the motor current. The motor current is after all a good indication of the loaded condition of the motor.

A better indication of the loaded condition of the electric motor can be obtained when the load indicating means are adapted to measure the rotation speed of the motor. The particular combination of motor rotation speed and motor current gives a good indication of the load.

Yet another preferred embodiment provides load indicating means which are provided with means for measuring the motor temperature. The motor temperature is after all also a good indication of the loaded condition of the motor. The temperature per se is moreover a critical value; damage to the motor occurs when a determined limit value is exceeded.

The above stated measures produce good results particularly when the regulator circuit forms part of an electric hand tool; short (for instance drilling) as well as sustained (for instance sanding) loading of the diverse components does after all take place here, so that the use of a microprocessor provides many advantages.

According to yet another preferred embodiment, the regulator circuit is adapted to measure the motor current and to adjust the control of the semiconductor switching element for the purpose of correcting the motor current. With these measures a feedback is obtained so that the motor current can more easily be held constant. The regulating and control functions necessary for this purpose can be performed in simple manner by a microprocessor.

Measuring of the motor current not only serves to protect the motor or the switch or possible other components through which the current runs, but also to determine the torque produced by the motor. In the type of motor employed the motor current is after all proportional to the torque. The measuring of the motor current can thus be used to determine the torque. It is hereby possible, when the motor current exceeds a threshold value, to cut off, reduce or hold the motor current constant. This measure is particularly applicable to screwing machines.

A similar consideration applies to the situation in which control takes place on the basis of voltage instead of current. A preferred embodiment therefore provides the measure that the regulator circuit is adapted to measure the motor voltage when the semiconductor switching element is blocked and to adjust the control of the semiconductor switching element for the purpose of correcting the motor voltage.

Performing of a control with feedback on the basis of rotation speed is also an attractive option, particularly in the case of tools with a rotation speed which must be held as uniform as possible. This finds expression in a preferred embodiment wherein the regulator circuit is adapted to measure the motor rotation speed and to adjust the control of the semiconductor switching element for the purpose of correcting the motor rotation speed.

The application of a microprocessor also provides the option that the control circuit controls the semiconductor switching element such that the motor generates a pulsating torque, for instance with a frequency of about 3 Hz. This measure finds application particularly, though not exclusively, in screwing machines, for instance for loosening a screw or nut that is stuck fast, or for tightening a screw or nut. The application of a microprocessor makes it possible to readily implement such a function.

In battery-powered tools it is not only the motor which is a critically loaded component, but also the battery. Particularly with modern types of battery it is possible to achieve high performance in the sense of a high energy content at a small volume and weight, provided the charging and discharging processes in the battery are properly controlled. For this purpose a preferred embodiment of the invention provides the measure that the electric motor is suitable for powering by a rechargeable battery, that the regulator circuit is adapted to control the power supplied by the battery and that the battery is provided with condition indicating means which are adapted to generate a selection signal.

According to a further preferred embodiment, the regulator circuit is adapted to generate a gradually increasing torque when switched on. Practical problems such as the tool being knocked out of the hands when it is switched on are hereby obviated. It is hereby also easier to work in a more controlled manner.

Another preferred embodiment provides the measure that the regulator circuit is adapted to generate a gradually decreasing torque when switched off. This prevents the tool being knocked out of the hand of the user during operations in heavy materials.

In order to increase convenience of use it is attractive that the regulator circuit is adapted to store setting values. It is hereby possible for instance to store a maximum torque for tightening of screws into a determined type of wood.

A final preferred embodiment provides the measure that the regulator circuit is adapted to perform security functions against theft. An example hereof is performing a function which blocks operation. By keying in a code or inserting an element bearing a code, such as a key provided with a magnetic code, theft of such an expensive tool is made more difficult. It is also possible to make use of contactless code transfer.

Attention is drawn here to the fact that the above stated functions are particularly suitable for implementation by a microprocessor.

The present invention will be elucidated hereinbelow with reference to the accompanying drawings, in which:

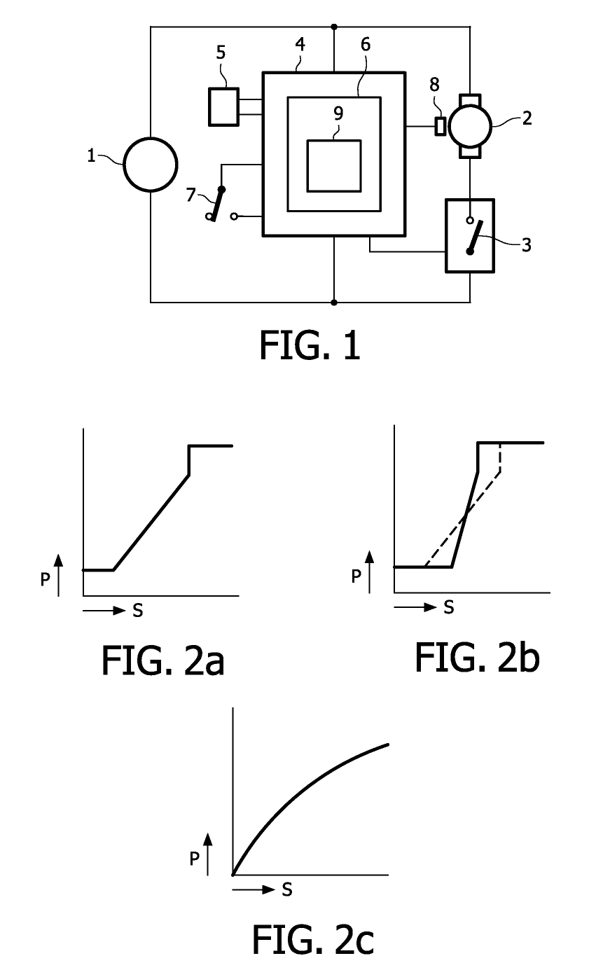

FIG. 1 shows a circuit diagram of an embodiment of the invention;

FIGS. 2a-c show diverse characteristics of the relation between input signal and power for the purpose of illustrating the operation of the invention, and

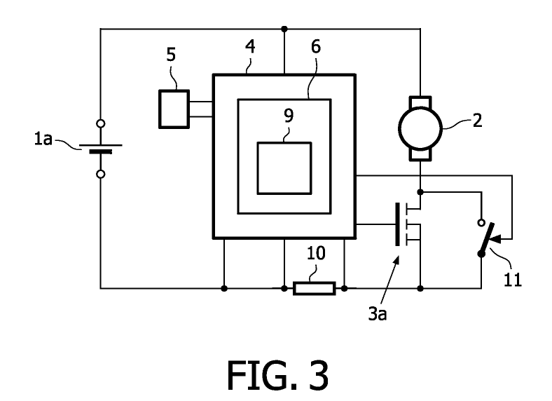

FIG. 3 shows a circuit diagram of an alternative embodiment.

FIG. 1 shows a circuit diagram of a regulator circuit according to the invention. The diagram shows a voltage source 1 which, depending on the desired application, can be formed by an alternating voltage source such as the mains supply or by a direct voltage source such as a rechargeable battery. The circuit controls the electric power which is fed to an electric motor 2. In the great majority of cases this electric motor 2 is formed by the type of motor known as a direct current motor, but which can however be adapted to power supply with alternating current. Between the voltage source and the motor is placed a switching element 3 which is adapted to transmit current for short periods of time and to otherwise block the current so as to thus regulate the power fed to electric motor 2 in the manner of pulse width modulation.

A control circuit 4 is arranged for the purpose of controlling switching element 3. This control circuit 4 is connected to switching element 3 for controlling thereof, and control circuit 4 is connected for its power supply to voltage source 1. For operation of control circuit 4 an operating element to be operated by the user is arranged, usually though not exclusively, in the form of a trigger which can be operated by a finger of the user. Thus far the described circuit corresponds with known prior art circuits as are usually applied in electric hand tools.

The circuit according to the present invention is distinguished from this known circuit by the presence of a microprocessor 6 in the control circuit. The low price of such microprocessors 6 makes it possible to apply these components in such regulator circuits, wherein microprocessor 6 enables diverse functions to be performed within control circuit 4. Such functions can generally not be performed, or only at high cost, in traditional control circuits, which are geared to their particular function.

An example of a function which is highly suitable for performing with a microprocessor is changing between two or more characteristics or relations between the operating signal generated by the operating element and the output power.

Reference is made here to FIGS. 2a-2c. FIG. 2a shows a characteristic suitable for power supply to an electric motor 2 in an electric hand tool. In order to facilitate starting of electric motor 2 a determined threshold power is fed to electric motor 2 immediately trigger switch 5 is pressed in. Only when trigger switch 5 is pressed in further does the power increase linearly with pressing in of trigger switch 5. At the end of the stroke of trigger switch 5 the characteristic shifts discontinuously to the maximum load so as to avoid excessive load on switching element 3. FIG. 2b shows a similar configuration, wherein the angle of inclination of the characteristic is slightly flatter. For comparison with the characteristic according to FIG. 2a, this latter characteristic is shown with dashed lines. Microprocessor 4 makes it possible to make use of one of the two characteristics, depending on the situation. The characteristic of FIG. 2b is thus more suitable for precise control of the rotation speed of electric motor 2. Use can be made of a selection switch 7, which can be operated by the user, in order to select the characteristic.

FIG. 2c shows a final example of a characteristic for the relation between operating signal and the power fed to motor 2. It will be apparent that the shown characteristics are only examples and that numerous other characteristics can be implemented in microprocessor 4.

Instead of the selection switch to be operated by the user, use can be made of other signals to select the characteristic, FIG. 1 shows an example of a temperature sensor 8 of motor 2. The microprocessor can herein be programmed such that, when a predetermined motor temperature is reached, the control switches to a characteristic which loads the motor less. This measure can otherwise also be carried out on the basis of the temperature of the switching element, which is usually embodied in the form of a semiconductor. For storing the data relating to the characteristics use is preferably made of a memory 9 which is preferably incorporated in the microprocessor.

FIG. 3 shows a second embodiment of the invention, which is particularly suitable for tools powered by a rechargeable battery. The voltage source is formed here by a battery 1a and the switching element is formed by a field effect transistor 3a. A short-circuit switch 11 controllable by control circuit 4 is arranged for the purpose of short-circuiting field effect transistor 3a. The device further comprises a current measuring circuit in the form of a resistor 10 with a low value which is placed between battery 1a and electric motor 2. The voltage over this resistor is hereby a measure for the motor current.

In the present circuit the microprocessor 6 provides the option of properly controlling the processes in and the charged condition of the battery. The measuring of the discharge current plays a part here. It is hereby possible to keep track of the charged condition so that advice can be given as to the moment at which the battery must be recharged. Measuring of the motor current moreover provides information for making decisions concerning short-circuiting of the field effect transistor, for instance when a high current value continues for longer than a predetermined period; short-circuiting of the field effect transistor does after all reduce the thermal load thereof considerably. A similar measure can also be implemented for motor 2.

It will be apparent that said applications of the microprocessor are numerous and that they are not limited to the above stated applications.

The following claims are presented for examination:

1. Regulator circuit for regulating the power fed to an electric motor from a voltage source, wherein the regulator circuit comprises:
a semiconductor switching element connected in series to the electric motor and the voltage source for the purpose of regulating the power fed to the electric motor;
a control circuit for controlling the semiconductor switching element;
a first operating element for operating the control circuit by means of an operating signal generated by the operating element and fed to the control circuit,
characterized in that a microprocessor is incorporated in the control circuit.

2. Regulator circuit as claimed in claim 1, characterized in that the microprocessor is adapted to regulate the power fed to the electric motor subject to the operating signal.

3. Regulator circuit as claimed in claim 2, characterized in that the microprocessor comprises a memory in which is stored a characteristic for the relation between the operating signal and the power fed to the electric motor.

4. Regulator circuit as claimed in claim 3, characterized in that at least two characteristics are stored in the memory of the microprocessor and that the microprocessor is adapted to make a choice between the characteristics.

5. Regulator circuit as claimed in claim 4, characterized in that the regulator circuit is provided with a switch for generating a selection signal.

6. Regulator circuit as claimed in claim 4, characterized in that the motor is provided with a load-indicating means, and that the load-indicating means are adapted to generate a selection signal.

7. Regulator circuit as claimed in claim 6, characterized in that the load-indicating means are provided with means for measuring the magnitude of the motor current.

8. Regulator circuit as claimed in claim 7, characterized in that the load-indicating means are adapted to measure the rotation speed of the motor.

9. Regulator circuit as claimed in claim 6, characterized in that the load-indicating means are provided with means for measuring the motor temperature.

10. Regulator circuit as claimed in claim 1, characterized in that the circuit is incorporated in an electric hand tool.

11. Regulator circuit as claimed in claim 1, characterized in that the regulator circuit is adapted to measure the motor current and to adjust the regulating of the semiconductor switching element for the purpose of correcting the motor current.

12. Regulator circuit as claimed in claim 1, characterized in that the regulator circuit is adapted to measure the motor voltage when the semiconductor switching element stops and to adjust the regulating of the semiconductor switching element for the purpose of correcting the motor voltage.

13. Regulator circuit as claimed in claim 1, characterized in that the regulator circuit is adapted to measure the motor rotation speed and to adjust the regulation of the semiconductor switching element for the purpose of correcting the motor rotation speed.

14. Regulator circuit as claimed in claim 1, characterized in that the regulator circuit is adapted to cause a pulsating torque to be generated by the electric motor.

15. Regulator circuit as claimed in claim 1, characterized in that the electric motor is suitable for powering by a rechargeable battery, that the regulator circuit is adapted to regulate the power supplied by the battery and that the battery is provided with condition-indicating means which are adapted to generate a selection signal.

16. Regulator circuit as claimed in claim 1, characterized in that the control circuit is adapted to generate a gradually increasing torque when switched on.

17. Regulator circuit as claimed in claim 1, characterized in that the regulator circuit is adapted to generate a gradually decreasing torque when switched off.

18. Regulator circuit as claimed in claim 1, characterized in that the regulator circuit is adapted to store setting values.

19. Regulator circuit as claimed in claim 1, characterized in that the regulator circuit is adapted to perform security functions against theft.
